(19) United States
(12) Patent Application Publication
(10) Pub. No.: US 2005/0181223 A1
(43) Pub. Date: Aug. 18, 2005

(54) Flexible metal foil-polyimide laminate and making method

(75) Inventors: Michio Aizawa, Ibaraki-ken (JP); Masahiro Usuki, Ibaraki-ken (JP); Tatsuya Fujimoto, Ibaraki-ken (JP); Shigehiro Hoshida, Ibaraki-ken (JP); Tadashi Amano, Ibaraki-ken (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/046,751

(22) Filed: Feb. 1, 2005

(30) Foreign Application Priority Data
Feb. 17, 2004 (JP) 2004-039634

(51) Int. Cl. C08G 69/26

(52) U.S. Cl. 428/458

(57) ABSTRACT

A flexible metal foil-polyimide laminate is prepared by joining a polyimide film to a metal foil via an intervening adhesive layer. The adhesive is a mixture of polyamic acids: (A) the reaction product of 3,4,3′,4′-biphenyltetracarboxylic anhydride with p-phenylenediamine, (B) the reaction product of 3,4,3′,4′-biphenyltetracarboxylic anhydride with 4,4′-diaminodiphenyl ether, and (C) the reaction product of pyromellitic dianhydride with 4,4′-diaminodiphenyl ether, in a weight ratio (A+B)/C between 75/25 and 25/75. The method is simple and inexpensive, and yields a flexible metal foil-polyimide laminate that is improved in peel strength and curling resistance while maintaining the heat resistance of polyimide.

### CROSS-REFERENCE TO RELATED APPLICATION

This non-provisional application claims priority under 35 U.S.C. §119(a) on Patent Application No. 2004-039634 filed in Japan on Feb. 17, 2004, the entire contents of which are hereby incorporated by reference.

### TECHNICAL FIELD

This invention relates to flexible metal foil-polyimide laminates for use in electronic components, typically printed wiring boards, and a method for preparing the same.

### BACKGROUND ART

JP-A 62-212140 discloses a process (designated Process 1) of preparing a flexible substrate by applying a polyimide precursor resin solution directly onto a conductor, followed by drying and curing. Process 1 which does not use any adhesive offers advantages including reduced curling and improved heat resistance. Albeit such advantages, issues of some curling and poor bond strength can arise, depending on the type of a particular polyimide precursor used. Also a process (designated Process 2) of applying a polyimide precursor resin solution in several divided portions onto a conductor is disclosed in JP-A 2-180682, JP-A 2-180679, JP-A 1-245586, and JP-A 2-122697.

In the process of preparing a flexible substrate by applying a polyimide precursor resin solution onto a conductor, the flexible substrate lacks the so-called “body” (or a kind of stiffness) and is awkward to handle if the thickness of the finally finished polyimide layer is less than 20 microns. Thus, the polyimide precursor resin must be thickly applied and cured to the conductor so that the finally finished polyimide layer may have a thickness of 20 microns or greater. It is difficult to apply a thick coating to a uniform thickness, often resulting in a variation of thickness, i.e., a coating failure. In this regard, Process (2) of applying in several divided portions has a propensity that as the number of applying steps increases, thickness variations become extremely prominent. Additionally, Process (2) of applying in several divided portions takes a long time in the overall manufacturing process because coating and drying steps must be repeated.

### SUMMARY OF THE INVENTION

An object of the invention is to provide flexible metal foil-polyimide laminates which take full advantage of a polyimide resin having heat resistance and have improved peel strength and minimized curling; and a method of preparing the same.

In joining a metal foil to a polyimide film through an intervening adhesive layer to prepare a flexible metal foil-polyimide laminate, the inventors attempted to use a polyamic acid as the adhesive. It has been found that when a mixture of polyamic acids: (A) the reaction product of 3,4,3′,4′-biphenyltetracarboxylic anhydride with p-phenylenediamine, (B) the reaction product of 3,4,3′,4′-biphenyltetracarboxylic anhydride with 4,4′-diaminodiphenyl ether, and (C) the reaction product of pyromellitic dianhydride with 4,4′-diaminodiphenyl ether, in a weight ratio (A+B)/C between 75/25 and 25/75 is used as the adhesive, there is obtained a flexible metal foil-polyimide laminate which takes full advantage of polyimide resin having heat resistance.

In one aspect, the present invention provides a flexible metal foil-polyimide laminate comprising a metal foil and a polyimide film stacked thereon with an adhesive layer intervening therebetween. The adhesive layer is obtained by imidization of a polyamic acid mixture comprising

(A) a polyamic acid which is the reaction product of 3,4,3′,4′-biphenyltetracarboxylic anhydride with p-phenylenediamine,

(B) a polyamic acid which is the reaction product of 3,4,3′,4′-biphenyltetracarboxylic anhydride with 4,4′-diaminodiphenyl ether, and

(C) a polyamic acid which is the reaction product of pyromellitic dianhydride with 4,4′-diaminodiphenyl ether, in a weight ratio (A+B)/C between 75/25 and 25/75.

In another aspect, the present invention provides a method for preparing a flexible metal foil-polyimide laminate comprising joining a metal foil to a polyimide film through an adhesive layer disposed therebetween, wherein the above-described polyamic acid mixture is used as the adhesive. The laminate is preferably prepared by applying an adhesive to a metal foil and joining a polyimide film to the metal foil so that the adhesive layer is interleaved between them.

In a preferred embodiment, the polyamic acid mixture contains polyamic acids (A) and (B) in a weight ratio A/B between 10/90 and 90/10. Typically, the metal foil is a copper foil having a thickness of at least 9 μm, the polyimide film has a thickness of at least 12 μm, and the adhesive layer has a thickness of up to 10 μm.

The laminate preparation method of the invention is simple and inexpensive, and yields a flexible metal foil-polyimide laminate of all polyimide nature that is improved in peel strength and curling resistance while maintaining the heat resistance of polyimide.

### DESCRIPTION OF THE PREFERRED EMBODIMENTS

The flexible metal foil-polyimide laminate of the present invention is a stack of a metal foil and a polyimide film with an adhesive layer intervening therebetween. The adhesive used herein is a polyamic acid mixture comprising

(A) a polyamic acid which is the reaction product of 3,4,3′,4′-biphenyltetracarboxylic anhydride with p-phenylenediamine,

(B) a polyamic acid which is the reaction product of 3,4,3′,4′-biphenyltetracarboxylic anhydride with 4,4′-diaminodiphenyl ether, and

(C) a polyamic acid which is the reaction product of pyromellitic dianhydride with 4,4′-diaminodiphenyl ether, in a weight ratio (A+B)/C between 75/25 and 25/75. The adhesive layer is obtained by imidization of the polyamic acid mixture.

The polyamic acid mixture used as the adhesive contains three different polyamic acids (A), (B) and (C) in such a proportion that the ratio of (A+B)/C is between 75/25 and 25/75, preferably between 70/30 and 30/70, and more preferably between 60/40 and 40/60, by weight. If the mixing ratio of (A+B)/C exceeds 75/25, the peel strength to metal foil becomes weak. If the mixing ratio of (A+B)/C is below 25/75, the adhesive layer itself tend to allow curling, which is unwanted in handling.

In a preferred embodiment, the polyamic acid mixture contains polyamic acids (A) and (B) in a ratio A/B between 10/90 and 90/10, more preferably between 15/85 and 85/15, and even more preferably between 20/80 and 80/20, by weight. If the weight ratio of A/B exceeds 90/10, there is a tendency that peel strength lowers. If the weight ratio of A/B is less than 10/90, the adhesive layer may be degraded in dimensional stability.

The polyamic acids (A), (B) and (C) can be prepared by well-known techniques using the above-described monomers. Solvents are used in the reactions to produce these polyamic acids (A), (B) and (C). Examples of suitable solvents include dimethylacetamide (DMAc), N-methylpyrrolidone (NMP), dimethyl sulfoxide (DMSO), dimethyl sulfate, sulfolane, butyrolactone, cresol, phenol, halogenated phenols, cyclohexanone, dioxane, tetrahydrofuran, and diglyme, with N,N′-dimethylacetamide and N-methyl-2-pyrrolidone being preferred. Each reaction may be carried out in any of the above-mentioned solvents alone or in admixture, at a temperature of 10 to 40° C. and a reaction solution concentration of up to 30%. It is preferred to react an aromatic tetracarboxylic anhydride and an aromatic amine in a molar ratio between 0.95:1.00 and 1.05:1.00, and more preferably in a nitrogen atmosphere. In this reaction, how to dissolve and add the starting monomers is not particularly limited.

The polyamic acids (A), (B) and (C) each preferably have a weight average molecular weight of 10,000 to 100,000, and more preferably 10,000 to 50,000, as measured by gel permeation chromatography (GPC) using polystyrene standards. With a Mw in excess of 100,000, the reaction solution suffers a viscosity build-up. With a Mw of less than 10,000, the adherence to metal foil becomes poor.

It is understood that GPC measurement is performed under the following conditions.

Measuring conditions:

Column: Shodex KD-80MX2

Elute: tetrahydrofuran/dimethylformamide=1/1 (10 mM LiBr)

Flow velocity: RI

Apparatus: HLC-8020 (Toso Co., Ltd.)

The liquid mixture resulting from mixing of the three components (A), (B) and (C) should preferably have a viscosity of 1,500 to 4,000 mPa.s at 25° C., and more preferably 2,000 to 3,500 mPa.s at 25° C. A viscosity of less than 1,500 mPa.s or more than 4,000 mPa.s makes it difficult to apply the mixture to a metal foil. It is noted that for viscosity measurement, a system including a single cylinder rotation viscometer, a calibrated thermometer as an auxiliary instrument, and a thermostat tank with a circulating pump which is kept at 25° C. is used, and measurement is carried out when the sample reaches 25° C.

The mixture of components (A), (B) and (C) is obtained by combining together the reaction solutions of polyamic acid syntheses as reacted, and then applied as varnish to a metal foil or polyimide film, preferably to a metal foil. The varnish preferably contains solids from the mixture of components (A), (B) and (C) in a range of 8 to 15% by weight. With less than 8 wt % of solids, the varnish has too low a viscosity to apply, often resulting in coating variations. With more than 15 wt % of solids, the varnish has too high a viscosity and is difficult to handle. The varnish is preferably applied to such a build-up that the coat cured by imidization may have a thickness of 10 μm or less.

As used herein, the term “varnish” is equivalent to the polyamic acid mixture.

In the varnish prior to use, inorganic substances, organic substances or fibers may be admixed for the purpose of improving various properties. It is also possible to add additives like antioxidants for preventing the conductor from oxidation, or silane coupling agents for improving adhesion.

Examples of the metal foil used in the flexible metal foil-polyimide laminate include copper, aluminum, iron and nickel. Of these examples, rolled copper foil is preferred. The metal foil used herein should preferably have a thickness of 5 to 100 μm. A rolled copper foil having a thickness of at least 9 μm is especially preferred. A too thin metal foil has a low strength (weak body) and tends to wrinkle during the varnish coating and laminating steps, sometimes requiring the use of a protector.

The polyimide film used herein should preferably have a high initial tensile modulus and a coefficient of linear expansion which is approximate to that of copper. More specifically, the initial tensile modulus is at least 325 kg/mm² (ASTM D882) and the coefficient of linear expansion is approximate to 1.6×10⁻⁵/° C. in the temperature range of 100 to 200° C. (TMA). Such polyimide films are commercially available under the trade name of Kapton from Dupont and Apical from Kaneka Corp. The polyimide film should preferably have a thickness in the range of 7.5 to 125 μm, more preferably at least 12 μm.

Prior to the laminating step, the polyimide film may be pretreated, for example, by a plasma treatment or etching treatment on the surface of the polyimide film.

In a preferred embodiment of the invention, the polyamic acid mixture or varnish is applied to the surface of a metal foil and dried. The apparatus and technique used in this step are not particularly limited. There may be used any of coating devices including comma coaters, T dies, roll coaters, knife coaters, reverse coaters and lip coaters.

In a preferred embodiment of the invention, the polyamic acid mixture or varnish is applied to the surface of a metal foil and dried to form an adhesive layer, after which a polyimide film is laminated thereon by any desired technique such as roller pressing. The roller pressing should be carried out while heating at least the roller that comes in contact with the metal foil. Means of heating the roller include direct heating of the roller with hot oil or steam. With respect to the material of the roller, metal rollers such as carbon steel and rubber rollers such as heat resistant fluoro-rubber and silicone rubber are used. Although roller pressing conditions are not particularly limited, the preferred conditions include a temperature in the range of 100 to 150° C., which is below the boiling point of the solvent for polyamic acids, and a linear pressure in the range of 5 to 100 kg/cm.

The lamination is followed by drying (solvent removal) and imidization. The drying may be carried out until the solvent is removed, typically for about 3 to 30 hours. The imidization may follow the solvent removal immediately and be carried out, as in the conventional process, in a reduced pressure atmosphere with an oxygen concentration low enough to prevent the metal foil surface from oxidation, typically up to 2% by volume, or in a nitrogen atmosphere, at 250 to 350° C. for about 3 to 20 hours. During the solvent removal and imidization, the laminate may take a sheet or roll form. In the case of roll form, how to wind into a roll is not critical, for example, the metal foil may be either inside or outside, and a spacer may be interleaved.

During the solvent removal and imidization following the lamination involved in the inventive method, there will be present the residual solvent after lamination and the water formed upon imidization, which are both to be removed. Then the laminate in the preferred form of a loosely wound roll or a roll with a spacer of different material interleaved may be subjected to heat treatment.

It is noted that the adhesive layer preferably has a thickness of up to 10 μm, more preferably 3 to 7 μm, and even more preferably 5 to 6 μm. Too thick an adhesive layer is difficult to dry after coating. Too thin an adhesive layer is less adherent to the metal foil.

### EXAMPLE

Examples of the invention are given below together with Comparative Examples by way of illustration and not by way of limitation.

### Example 1

### Synthesis of Polyamic Acids

(A) 108 g of p-phenylenediamine was added to 3,216 g of N-methyl-2-pyrrolidone, which were stirred for dissolution in a N₂ atmosphere. To the solution, 294 g of 3,4,3′,4′-biphenyltetracarboxylic dianhydride was added so slowly that the internal temperature might not exceed 10° C. After the completion of addition, the internal temperature was raised to 40° C., at which reaction took place for 2 hours. The resulting polyamid acid had a weight average molecular weight of 42,000 as measured by GPC. There was obtained a reaction solution containing 12.5% by weight of polyamic acid.

(B) 200 g of 4,4′-diaminodiphenyl ether was added to 3,952 g of N-methyl-2-pyrrolidone, which were stirred for dissolution in a N₂ atmosphere. To the solution, 294 g of 3,4,3′,4′-biphenyltetracarboxylic dianhydride was added so slowly that the internal temperature might not exceed 10° C. After the completion of addition, the internal temperature was raised to 40° C., at which reaction took place for 2 hours. The resulting polyamic acid had a weight average molecular weight of 48,000 as measured by GPC. There was obtained a reaction solution containing 12.5% by weight of polyamic acid.

(C) 200 g of 4,4′-diaminodiphenyl ether was added to 3,152 g of N,N′-dimethylacetamide, which were stirred for dissolution in a N₂ atmosphere. To the solution, 194 g of pyromellitic dianhydride was added so slowly that the internal temperature might not exceed 15° C. After the completion of addition, reaction took place at 15° C. for 2 hours and then at room temperature for 6 hours. The resulting polyamic acid had a weight average molecular weight of 36,000 as measured by GPC. There was obtained a reaction solution containing 12.5% by weight of polyamic acid.

Preparation of Polyamic Acid Varnish as Adhesive

The polyamic acid reaction solutions (components A, B and C) obtained above were used without isolation, weighed and combined so that the weight ratio of (A+B)/C was (9+50)/41. Specifically, 9 g of the reaction solution (A), 50 g of the reaction solution (B), and 41 g of the reaction solution (C) were metered into a 200-cc beaker where they were thoroughly stirred with a glass bar for 20 minutes. The mixture was held in a reduced pressure of 300 mmHg for 10 minutes for deaeration. This yielded a varnish containing 12.5% by weight of polyamic acids combined and had a viscosity of 2,600 mPa.s at 25° C.

Preparation of Laminate

Using an applicator, the polyamic acid varnish prepared above was applied onto a 30 cm×25 cm piece of 35-μm rolled copper foil to a wet coating thickness of 40 μm. The coating was dried in an oven at 120° C. for 5 minutes. A 30 cm×25 cm piece of 25-μm polyimide film (Apical NPI by Kaneka Corp., initial tensile modulus 420 kg/mm², coefficient of linear expansion 1.6×10⁻⁵/° C. at 100-200° C.) was overlaid on the varnish coat. Using a test roll laminator (Nishimura Machinery Co., Ltd.), the laminate form was pressed at 120° C., a pressure of 15 kg/cm and a rate of 4 m/min. In a N₂ inert oven, the laminate form was continuously heat treated at 160° C. for 4 hours, at 250° C. for 1 hour, and then at 350° C. for 1 hour. The resulting laminate included a copper foil of 35 μm thick and a polyimide layer (adhesive layer+polyimide film) of 30 μm thick.

The laminate was examined by the following tests.

Peel Strength

According to JIS C6471, a sample on which a circuit pattern of 1 mm wide was formed was measured for peel strength at a pulling rate of 50 mm/min and a peeling angle of 1800.

Solder Heat Resistance

A sample was immersed in a solder bath at 360° C. for 30 seconds, after which it was visually observed for delamination or blisters.

Curling

A 12 cm×12 cm piece of polyimide film was rested on a horizontal platform. If opposite edges of the film separated apart from the platform, the distance was measured. If the film piece curled so much and became round, the diameter of the rounded film was measured and reported in Table 2.

### Examples 2-7

Examples 2 to 7 were implemented as in Example 1 except that components (A), (B) and (C) were combined in the mixing ratio shown in Table 1.

### Comparative Examples 1-3

Comparative Examples 1 to 3 were implemented as in Example 1 except that components (A), (B) and (C) were combined in the mixing ratio shown in Table 2.

### Comparative Example 4

(A) 10.8 g of m-phenylenediamine was added to 321.6 g of N-methyl-2-pyrrolidone, which were-stirred for dissolution in a N₂ atmosphere. To the solution, 29.4 g of 3,4,3′,4′-biphenyltetracarboxylic dianhydride was added so slowly that the internal temperature might not exceed 10° C. After the completion of addition, the internal temperature was raised to 40° C., at which reaction took place for 2 hours. The resulting polyamic acid had a weight average molecular weight of 44,000 as measured by GPC.

(B) 24.3 g of 2-hydroxy-4,4′-diaminobenzanilide was added to 452 g of dimethylacetamide, which were stirred for dissolution in a N₂ atmosphere. To the solution, 32.2 g of 3,4,3′,4′-benzophenonetetracarboxylic dianhydride was slowly added. After the completion of addition, reaction took place for 3 hours at 25° C. The resulting polyamic acid had a weight average molecular weight of 24,000 as measured by GPC.

(C) 19.8 g of 4,4′-diaminodiphenyl methane was added to 392 g of dimethylacetamide, which were stirred for dissolution in a N₂ atmosphere. To the solution, 19.4 g of pyromellitic dianhydride was slowly added. After the completion of addition, reaction took place for 3 hours at 25° C. The resulting polyamic acid had a weight average molecular weight of 30,000 as measured by GPC.

The polyamic acid reaction solutions (components A, B and C) obtained above were weighed and combined so that the weight ratio of (A+B)/C was (9+50)/41. After thorough mixing, the polyamic acid mixture was held in a reduced pressure of 300 mmHg for 10 minutes for deaeration. This yielded a varnish containing 11.5% by weight of polyamic acids combined and had a viscosity of 1,700 mPa.s at 25° C. As in Example 1, a laminate was prepared using this varnish and tested.

TABLE 1

| | Example | | | | | | |
|---|---|---|---|---|---|---|---|
| | 1 | 2 | 3 | 4 | 5 | 6 | 7 |
| A + B, wt % | 9 + 50 | 4 + 50 | 42.5 + 7.5 | 64 + 11 | 21 + 4 | 30 + 25 | 65 + 5 |
| A/B ratio | 15/85 | 7/93 | 85/15 | 85.3/14.7 | 84/16 | 54/46 | 94/6 |
| C, wt % | 41 | 46 | 50 | 25 | 75 | 45 | 30 |
| Solids in mixed | 12.5 | 12.5 | 12.5 | 12.5 | 12.5 | 12.5 | 12.5 |
| varnish, wt % | | | | | | | |
| Viscosity of mixed | 2,600 | 2,580 | 2,200 | 2,500 | 2,000 | 2,100 | 2,500 |
| varnish, | | | | | | | |
| mPa · s at 25° C. | | | | | | | |
| Peel strength, | 1.2 | 0.95 | 1.05 | 1.0 | 1.15 | 1.1 | 1.2 |
| kg/cm | | | | | | | |
| Solder heat resistance | intact | intact | intact | intact | intact | intact | intact |
| @360° C./30 s | | | | | | | |
| Curling, cm | 0.2 | 0.1 | 0.05 | 0 | 0.15 | 0.1 | 0.4 |

TABLE 2

| | Comparative Example | | | |
|---|---|---|---|---|
| | 1 | 2 | 3 | 4 |
| A + B, wt % | 85 + 15 | 0 | 9.5 + 0.5 | 9 + 50 |
| A/B ratio | 85/15 | 0 | 95/15 | 15/85 |
| C, wt % | 0 | 100 | 90 | 41 |
| Solids in mixed | 12.5 | 12.5 | 12.5 | 11.5 |
| varnish, wt % | | | | |
| Viscosity of mixed | 2,700 | 1,800 | 1,900 | 1,700 |
| varnish, mPa · s at 25° C. | | | | |
| Peel strength, | 1.1 | 1.0 | 1.0 | 1.0 |
| kg/cm | | | | |
| Solder heat resistance | intact | intact | intact | intact |
| @360° C./30 s | | | | |
| Curling, cm | 1.5 | curled to | curled to | curled to |
| | | 2 cm | 3 cm | 2 cm |
| | | diameter | diameter | diameter |

Japanese Patent Application No. 2004-039634 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A flexible metal foil-polyimide laminate comprising a metal foil and a polyimide film stacked thereon with an adhesive layer intervening therebetween,
said adhesive layer being obtained by imidization of a polyamic acid mixture comprising
(A) a polyamic acid which is the reaction product of 3,4,3′,4′-biphenyltetracarboxylic anhydride with p-phenylenediamine,
(B) a polyamic acid which is the reaction product of 3,4,3′,4′-biphenyltetracarboxylic anhydride with 4,4′-diaminodiphenyl ether, and
(C) a polyamic acid which is the reaction product of pyromellitic dianhydride with 4,4′-diaminodiphenyl ether, in a weight ratio (A+B)/C between 75/25 and 25/75.

2. The laminate of claim 1, wherein said polyamic acid mixture contains polyamic acids (A) and (B) in a weight ratio A/B between 10/90 and 90/10.

3. The laminate of claim 1, wherein said metal foil is a copper foil having a thickness of at least 9 μm, said polyimide film has a thickness of at least 12 μm, and said adhesive layer has a thickness of up to 10 μm.

4. A method for preparing a flexible metal foil-polyimide laminate comprising joining a metal foil to a polyimide film through an adhesive layer therebetween,
said adhesive being a polyamic acid mixture comprising
(A) a polyamic acid which is the reaction product of 3,4,3′,4′-biphenyltetracarboxylic anhydride with p-phenylenediamine,
(B) a polyamic acid which is the reaction product of 3,4,3′,4′-biphenyltetracarboxylic anhydride with 4,4′-diaminodiphenyl ether, and
(C) a polyamic acid which is the reaction product of pyromellitic dianhydride with 4,4′-diaminodiphenyl ether, in a weight ratio (A+B)/C between 75/25 and 25/75.

5. The method of claim 4, wherein said polyamic acid mixture contains polyamic acids (A) and (B) in a weight ratio A/B between 10/90 and 90/10.

6. The method of claim 4, wherein said metal foil is a copper foil having a thickness of at least 9 μn, said polyimide film has a thickness of at least 12 μm, and said adhesive layer has a thickness of up to 10 μm.
